(19) United States
(12) Patent Application Publication
(10) Pub. No.: US 2007/0062190 A1
(43) Pub. Date: Mar. 22, 2007

(54) SUPERCHARGING DEVICE FOR AN INTERNAL COMBUSTION ENGINE AND MOTOR VEHICLE PROVIDED WITH SUCH A DEVICE

(76) Inventor: Jean Frederic MELCHIOR, Paris (FR)

Correspondence Address: STITES & HARBISON PLLC, 1199 NORTH FAIRFAX STREET, SUITE 900, ALEXANDRIA, VA, 22314, US

(21) Appl. No.: 11/533,530

(22) Filed: Sep. 20, 2006

(30) Foreign Application Priority Data
Sep. 21, 2005 (FR) 05 09652

(51) Int. Cl. F02B 33/44

(52) U.S. Cl. 60/605.1; 60/612

(57) ABSTRACT

This device is of the type comprising a high-pressure turbine (20) and a low-pressure turbine (14) which are arranged in series, and a bypass pipe (32) for the high-pressure turbine (20) which connects a charging pipe (26) to an exhaust pipe (28) of the high-pressure turbine (20).

According to a feature of the invention, the bypass pipe (32) opens in the exhaust pipe (28) via a pressure-reduction nozzle (34) which allows the gases derived by the bypass pipe (32) to be discharged in a mixing portion (46) of the exhaust pipe (28) substantially in accordance with the direction and sense of flow in the mixing portion (46) of the gases which are depressurised in the high-pressure turbine (20), in order to increase the flow rate of the gases which are depressurised in the high-pressure turbine (20) by mixing with the derived gases.

### TECHNICAL FIELD

The present invention relates to a supercharging device for an internal combustion engine, of the type comprising a turbine which is connected to a compressor, a pipe for charging the turbine with pressurised gases, an exhaust pipe for the gases which are depressurised in the turbine, and bypass means for the turbine comprising a bypass pipe which connects the charging pipe to the exhaust pipe.

### BACKGROUND TO THE INVENTION

Conventionally in a supercharging device of this type, the turbine is charged with pressurised exhaust gases which are burnt by the engine and uses the energy from those exhaust gases in order to drive the compressor, which charges the engine with pressurised fresh air.

The turbine generally has such dimensions that the compressor supplies a desired air pressure to a partial rotation phase of the engine, during which phase the engine discharges a predetermined exhaust gas flow towards the turbine.

Above that partial phase, the exhaust gas flow increases, and leads to an increase in the exhaust counter-pressure upstream of the turbine and at the output of the engine, which may impair the effectiveness of the engine and in particular increase its fuel consumption.

The bypass means of the turbine allow the passage of a portion of the exhaust gases, referred to below as derived gases, directly from a location upstream of the turbine to a location downstream of the turbine, without passing through the turbine, so as to limit the counter-pressure upstream of the turbine at the precise level necessary to achieve the desired air pressure at the output of the compressor.

Nevertheless, the potential energy contained in the exhaust gases derived by the bypass means is inhibited integrally in terms of heat, and the mediocre energy yield of the supercharging device limits the proportion of exhaust gases which can be derived from the bypass means.

An object of the invention is to provide a supercharging device which has an improved yield, and which allows an increase in the proportion of exhaust gases which can be derived.

### SUMMARY OF THE INVENTION

To that end, the invention relates to a supercharging device for an internal combustion engine of the above-mentioned type, characterised in that the bypass pipe opens in the exhaust pipe via a pressure-reduction nozzle which allows the gases derived by the bypass pipe to be discharged in a mixing portion of the exhaust pipe substantially in accordance with the direction and sense of flow in the mixing portion of the gases which are depressurised in the turbine, in order to increase the flow rate of the gases which are depressurised in the turbine by mixing with the derived gases in accordance with the principle of an aerodynamic ejector whose propulsion flow is constituted by the gases derived by the bypass pipe, and the conveyed flow is drawn from the gases which are depressurised in the turbine.

According to other embodiments, the supercharging device comprises one or more of the following features, taken in isolation or according to any possible combination:
the cross-section of the neck of the nozzle is adjustable;
the nozzle comprises a convergent annular channel which is delimited by the internal wall of a convergent member and the external wall of a closure member whose relative position can be adjusted between a position for closing the nozzle and a maximum opening position of the nozzle;
the conveyed flow is introduced into the mixing portion inside the propulsion flow;
the internal wall of the convergent member of the nozzle is a convergent extension of an internal wall of the mixing portion and the closure member is a tubular sleeve, the external surface of the sleeve delimiting the nozzle, and the internal surface of the sleeve delimiting an upstream portion of the exhaust pipe which charges the mixing portion with gases which are depressurised in the turbine;
the conveyed flow is introduced into the mixing portion outside the propulsion gas flow;
the mixing portion is charged with gases which are depressurised in the turbine via an annular channel which is contained between a widened portion which extends the mixing portion in an upstream direction and an external wall of the convergent member of the nozzle;
the turbine is a radial turbine which rotates about an axis, having a radial input and an axial output, the mixing portion extending in accordance with the axis of rotation of the turbine;
the nozzle is generated by revolution about an axis, an upstream portion of the mixing portion adjacent to the nozzle being generated by revolution about the axis of the nozzle, the mixing portion being developed in a downstream direction about that axis;
the turbine is a first turbine, the device comprising a second radial turbine which is arranged in series with the first turbine and which is charged with gases from a volute which is connected to the mixing portion of the exhaust pipe of the first turbine;
bypass means of the second turbine comprise a second bypass pipe which is charged from the exhaust pipe of the first turbine upstream of the nozzle of the bypass means of the first turbine, and which opens in a second exhaust pipe of the second turbine;
the internal wall of the mixing portion of the first turbine is a ruled surface which is supported on a circular cross-section of the upstream portion, which is generated by revolution, of the mixing portion and on the critical cross-section of the volute for charging the second radial turbine so as to constitute a tangential extension of that volute;
the cross-section of the neck of the nozzle of the derivation means of the first turbine can be adjusted between a minimum value, preferably zero, and a maximum value of between one and two times the critical cross-section of the first turbine, and the critical cross-section of the second turbine is between two and three times the critical cross-section of the first turbine; and
the mixing portion of the second turbine opens in a divergent diffuser which opens at means for processing the exhaust gases.

### BRIEF DESCRIPTION OF THE DRAWINGS

The invention and its advantages will be better understood from a reading of the following description which is given purely by way of example with reference to the appended drawings, in which:

FIG. 1 is a schematic view of an internal combustion engine comprising a supercharging device according to the invention;

FIG. 2 is a sectioned view of two turbines, which are arranged in series, of a supercharging device according to the invention; and

FIG. 3 is a view similar to that of FIG. 2, and shows the two turbines of a variant of a supercharging device.

### DESCRIPTION OF PREFERRED EMBODIMENTS

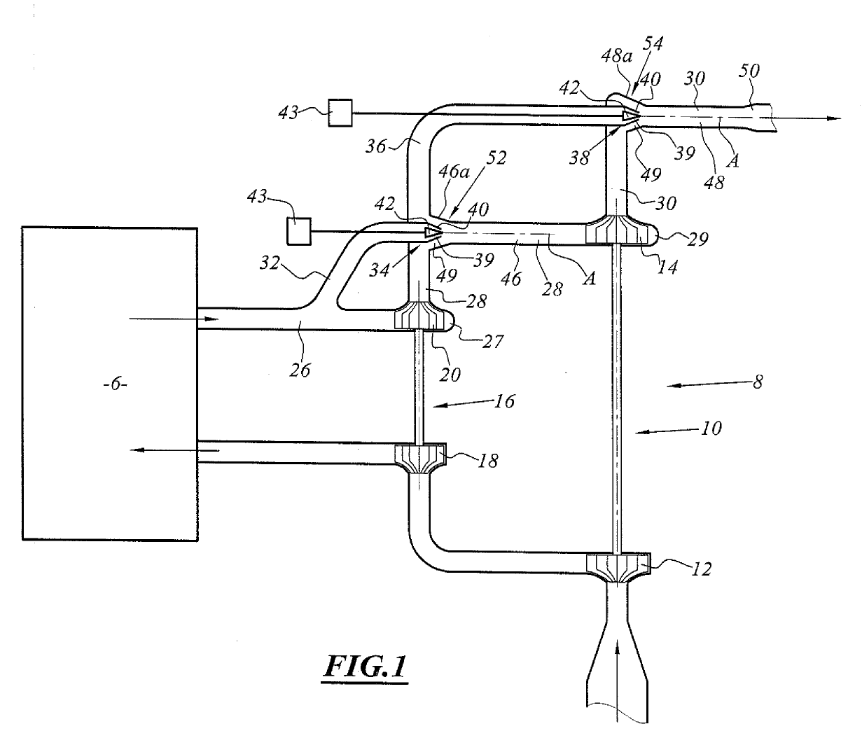

As illustrated in FIG. 1, the internal combustion engine 6 comprises a supercharging device 8 which comprises a low-pressure turbocompresser 10 which comprises a compressor 12 which is connected to a turbine 14 and a high-pressure turbocompresser 16 which comprises a compressor 18 which is connected to a turbine 20.

The compressors 12 and 18 are arranged in series and charge the engine 6 with pressurised fresh air. The compressor 18 is located downstream of the compressor 12.

The turbines 14 and 20 are arranged in series and receive the exhaust gases from the engine 6. The turbine 20 is located upstream of the turbine 14.

During operation, fresh air is compressed successively in the compressor 12 then the compressor 18 before being conveyed into the engine 6. The exhaust gases are successively depressurised in the turbine 20, then the turbine 14.

The turbine 20 is charged with gases from a supply pipe 26 which opens, for example, in a spiral-shaped charging volute 27 of the turbine 20 and discharges the depressurised gases in a first exhaust pipe 28.

The turbine 14 is charged with gases from the pipe 28, which therefore forms the charging pipe of the turbine 14, and discharges the depressurised gases in a second exhaust pipe 30. The pipe 28 opens in a spiral-shaped charging volute 29 of the turbine 14.

The device 8 comprises a first bypass pipe 32 of the turbine 20 which is charged from the pipe 26 and which opens in the pipe 28 via a first pressure-reduction nozzle 34.

The device 8 comprises a second bypass pipe 36 of the turbine 14 which is charged from the pipe 28 upstream of the nozzle 34 and which opens in the pipe 30 via a second pressure-reduction nozzle 38.

Each nozzle 34, 38 is defined by an annular channel 39 which is generated by revolution about an axis A which defines axis A of the nozzle 34, 38, and which is convergent towards the output of the nozzle as far as a neck, constituting the smallest cross-section of the nozzle 34, 38.

The channel 39 is delimited between an internal wall of a convergent tube 40 and a central body 42 which is arranged inside the tube 40.

The cross-section of the neck of each nozzle 34, 38 can be adjusted in order to adjust the flow of derived gases passing through the nozzle 34, 38.

To that end, the body 42 of each nozzle 34, 38 is mounted so as to be movable relative to the tube 40 in accordance with the axis A of the nozzle 34, 38 between an advanced position for closing the nozzle 34, 38, in which the body 42 is in substantially sealing contact with the internal wall of the tube 40, and a retracted maximum opening position, in which a space is provided between the internal wall of the tube 40 and the body 42.

The displacement of each body 42 is controlled by a linear actuator 43.

Each nozzle 34, 38 opens in a portion 46, 48 of the corresponding exhaust pipe 28, 30. Each portion 46, 48 is charged with depressurised gases from the turbine 20, 14 via an annular channel 49 which is delimited between the internal wall of a widened portion 46a, 48a which extends the portion 46, 48 in an upstream direction, and an external wall of the tube 40 of the nozzle 34, 38.

Each portion 46, 48 extends in a substantially rectilinear manner downstream of the corresponding nozzle 34, 38 substantially along the axis A of the nozzle 34, 38. Therefore, the nozzles 34, 38 are orientated so as to discharge the gases which are derived from the portions 46, 48 in the direction and sense of flow of the gases in those portions 46, 48.

Preferably, each nozzle 34, 38 is generated by revolution about the axis A thereof, each portion 46, 48 being developed in a downstream direction about the axis A of the nozzle 34, 38 which opens in that portion 46, 48.

The portion 46 opens in the volute 29.

The portion 48 opens in a divergent diffuser 50 which opens, for example, at means for processing the exhaust gases.

The total gas pressure P is equal to the sum of a static pressure P_{static} and a dynamic pressure P_{dynamic}, which is proportional to the density of the gases and the square of the speed of flow of the gases.

During operation, the gases from the engine 6 are introduced into the turbine 20 at a total pressure P1, are depressurised in the turbine 20 to a total pressure P2, less than P1, are introduced into the turbine 14 at a total pressure P3, are depressurised in the turbine 14 to a total pressure P4, less than P3, and are conveyed to the input of the diffuser 50 at a total pressure P5.

When the body 42 of the nozzle 34 is in a closure position, the total pressure P3 is substantially equal to the total pressure P2.

When the body 42 of the nozzle 34 is in an open position, a flow of derived gases, at pressure P1, flows in the pipe 32 from a location upstream to a location downstream of the turbine 20 without passing through the turbine 20. The flow of derived gases in the pipe 32 depends on the opening of the nozzle 34. The wider the nozzle 34 is open, the greater the proportion of derived gases.

The derived gases are discharged by the nozzle 34 in the portion 46 with pressure reduction and an increase in their flow rate which results from converting their pressure energy into kinetic energy. The derived gases are discharged with a flow rate greater than that of the depressurised gases in the turbine 20.

The dimensions of the portion 46 are provided in order to promote the exchanges of flow rate. In particular, the length L of the portion 46 is preferably between 5 and 10 times the diameter D thereof.

The gases discharged by the nozzle 34 and a portion of the gases depressurised in the turbine 20 mix in the portion 46 with an exchange of flow rate so that the flow rate of the gases depressurised in the turbine 20 is increased, and the flow rate of the mixed gases, resulting from mixing the gases depressurised in the turbine 20 with the gases derived from the pipe 30, is greater than that of the gases which are depressurised in the turbine 20 upstream of the nozzle 34.

Thus, the nozzle 34 defines with the portion 46 an aerodynamic ejector 52 which draws a propulsion flow of gases (the derived gases) upstream of the turbine 20 and a conveyed flow of gases downstream of the turbine 20, and which mixes the propulsion flow and the conveyed flow with an exchange of flow rate in order to increase the flow rate of the conveyed flow.

At the intake of the turbine 14, the mixed gases have a static pressure P3_{static} which is substantially equal to the static pressure P2_{static} of the depressurised gases in the turbine 20, and a dynamic pressure P3_{dynamic} greater than that P2_{dynamic} of the gases depressurised in the turbine 20. The total pressure P3 is therefore greater than the total pressure P2 and greater energy can be recovered in the turbine 14.

Therefore, the ejector 52 allows conversion of the pressure of the derived gases into kinetic energy and the use of that kinetic energy in order to increase the pressure at the intake of the turbine 14. Thus, greater energy is recovered in the turbine 14 and the overall yield of the supercharging device 8 is increased.

That increased yield allows an increase in the proportion of derived gases and an increase in the performance characteristics of the engine 6, in particular at high speeds, in which the flow of exhaust gases is far greater than the flow necessary in order to obtain the desired air pressure at the output of the compressor 18.

In order to promote the mixing of the conveyed flow and the propulsion flow, the internal wall of the portion 46 is preferably a ruled surface which is supported on a circular intake cross-section of the portion 46 that is located substantially in line with the output of the nozzle 34, and on the critical intake cross-section of the charging volute of the turbine 14, and the portion 46 constitutes a tangential extension of the volute 29.

Taking as a hypothesis that the total pressure P1 is equal to 6 bar and the total pressure P2 is equal to 3 bar, when the nozzle 34 is closed, that gives approximately P3=P2=3 bar.

The invention allows the possibility of recovering, when the nozzle 34 is open so as to derive 50% of the gases, 1 bar of dynamic pressure, and therefore to obtain a total pressure P3 of 4 bar, greater than the total pressure P2.

Similarly, the nozzle 38 defines with the portion 48 a second aerodynamic ejector 54 which draws a propulsion flow of gases upstream of the turbine 14 and a conveyed flow of gases downstream of the turbine 14, and which mixes the propulsion flow and the conveyed flow with an exchange of flow rate.

In this manner, when the body 42 of the nozzle 38 is in a closure position, the total pressure P5 is equal to the total pressure P4, and when the body 42 of the nozzle 38 is in an open position, the total pressure P5 is greater than the total pressure P4.

The pipe 36 is charged from the pipe 28 upstream of the ejector 52 and does not disrupt the operation of the ejector 52. Since the nozzle 34 is constructed in order to discharge the downstream gases in the portion 46, those gases are not likely to ascend towards the intake of the pipe 36.

The bypass means of the turbine 14 allow an increase in the pressure-reduction rate of the turbine 14, that is to say, the ratio of the total pressure P3 at the intake of the turbine 14 relative to the static pressure P4_{static} at the output of the turbine 14.

The nozzle 38 when open allows an increase in the pressure P5, and a lower static pressure P4_{static} is necessary at the output of the turbine 14 than when the nozzle 38 is closed in order to obtain downstream a pressure P5 which is sufficient for the flow of gases. Consequently, the pressure-reduction rate of the turbine 14 is increased and the energy recovered by the turbine 14 is greater.

Furthermore, when the nozzle 38 is open, the mass of depressurised gases in the turbine 20 flowing in the portion 46 decreases. Consequently, in the ejector 52, the proportion of high-energy gases (the gases from the nozzle 34) increases relative to that of the low-energy gases (the gases depressurised in the turbine 20), the flow rate of the mixed gases increases and, finally, the total pressure P3 increases.

Therefore, opening the nozzle 38 brings about both an increase in the total pressure P3 and a decrease in the static pressure P4_{static}. That allows an increase in the energy recovered from the turbine 14 and in the yield of the device 8.

Preferably, in order to obtain a satisfactory distribution of the energy between the turbines 14 and 20, the cross-section of the neck of the nozzle 34 can be adjusted between a minimum value, preferably zero, and a maximum value substantially between one and two times the critical cross-section of the turbine 20, and the critical cross-section of the turbine 14 is between two and three times the critical cross-section of the turbine 20.

The portion 46 is preferably slightly convergent in order to accelerate the flow of gases as far as the critical cross-section of the charging volute of the turbine 14. The portion 48 is preferably cylindrical.

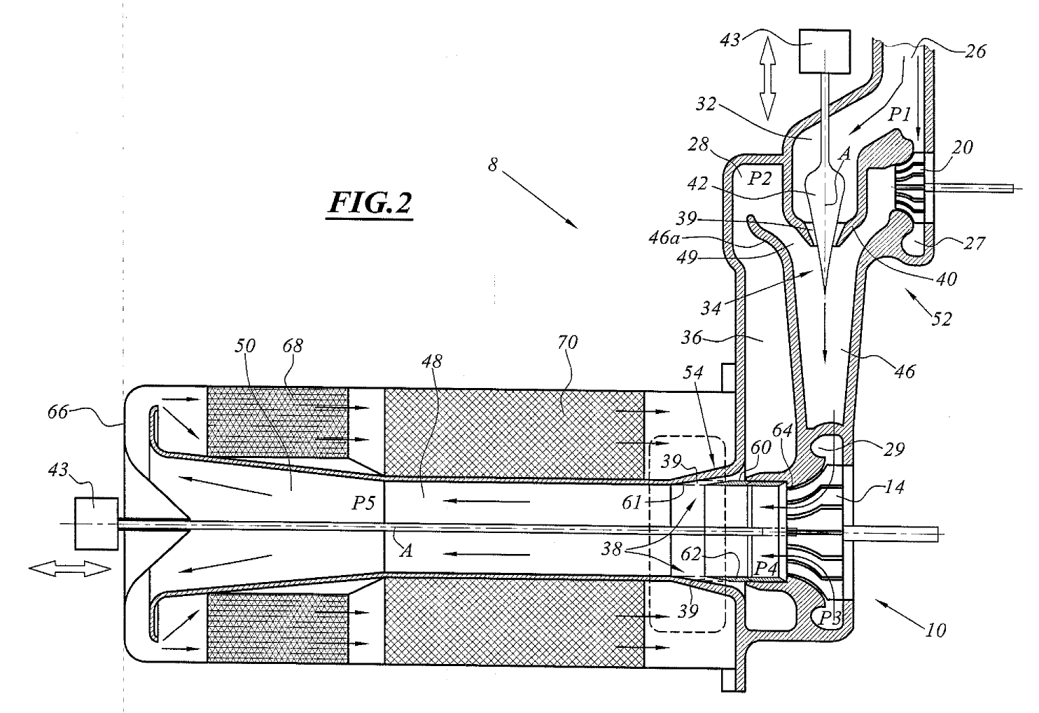

The embodiment illustrated in FIG. 2, in which the reference numerals for similar elements have been re-used, differs from the preceding embodiment in terms of the construction of the ejector 54, which allows the propulsion flow of gases to be introduced outside the conveyed flow of gases.

To that end, the channel 39 of the nozzle 38 is delimited between an internal wall of a convergent extension 61 of the channel 48 and the external surface 60 of a cylindrical tubular sleeve 62 in accordance with axis A of the nozzle 38, whose internal surface 64 defines a portion of the exhaust pipe 30 of the turbine 14 extending between the turbine 14 and the mixing portion 48.

In order to adjust the cross-section of the neck of the nozzle 38, the sleeve 62 is mounted so as to be movable relative to the convergent member 61 in accordance with the axis A of the nozzle 38 under the action of a linear actuator 43, between a closed position of the nozzle 38, in which a conical end 64 of the sleeve 62 is in substantially sealing contact with the internal wall of the convergent member 61, and an open position, in which a space is provided between the internal wall of the convergent member 61 and the end 64.

The internal wall of the convergent member 61 is an extension in an upstream direction of an internal wall of the mixing portion 48.

As illustrated in FIG. 2, in an ejector of the same type as the ejector 52, the body 42 of the nozzle 34 advantageously extends downstream by means of a conical point in order to bring about a continuous development of the cross-sections of the pipe.

The diffuser 50 opens at a radial diffuser 66 which provides means for processing the exhaust gases 68, 70, for example, a particulate filter or catalytic converter, which means are annular around the diffuser 50 and the portion 48 in order to maintain the compactness of the engine 6.

It should be noted that the turbine 14 is a radial turbine in accordance with axis A of the nozzle 38, the turbine having a radial intake and axial output. The gases advantageously flow out of the turbine 14 in accordance with axis A of the nozzle 38 and the portion 48.

This allows exploitation of the flow rate of the gases which are depressurised in the turbine 14, and therefore their dynamic pressure P4_{dynamic}, even if it is weak, and a further improvement in the yield of the device 8.

By way of a variant, the ejector 52 is of the same type as the ejector 54, that is to say that it allows an introduction of the propulsion flow of gases outside the conveyed flow of gases.

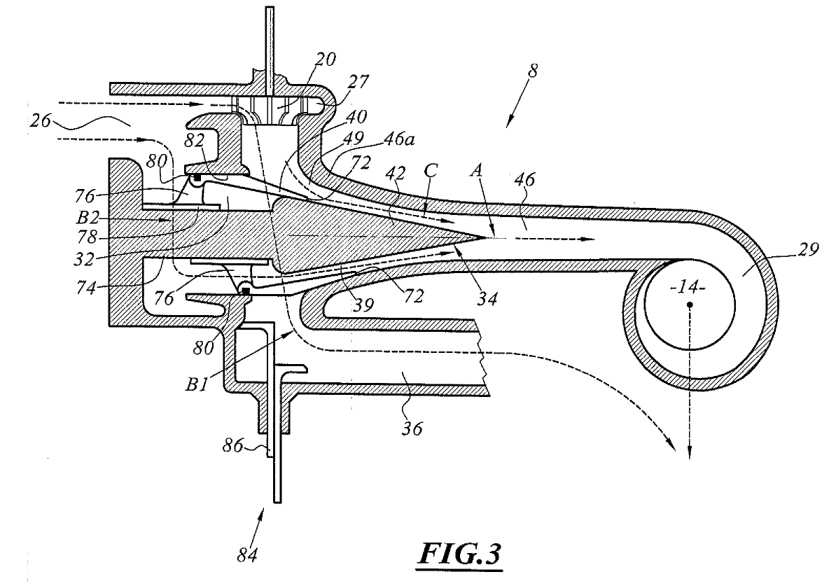

The device 8 according to the embodiment illustrated in FIG. 3, in which reference numerals relating to elements similar to those of FIGS. 1 and 2 have been re-used, differs from that in FIG. 2 in that it allows closure of the charging channel 49 of the portion 46 with gases depressurised in the turbine 20.

To that end, the tube 40 of the nozzle 34 is mounted so as to slide relative to the casing of the turbine 20 in accordance with axis A of the nozzle 34, between a retracted position in which the channel 39 is closed and the channel 49 is open, and an advanced position in which the external surface of a front end 72 of the tube 40 is in sealing contact with the internal wall of the widened portion 46a so that the channel 49 is closed, the channel 39 being open. In FIG. 3, a first half (at the top in FIG. 3) of the tube 40 is illustrated in retracted position and a second half (at the bottom in FIG. 3) of the tube 40 is illustrated in advanced position.

The central body 42 is mounted so as to be fixed relative to the casing of the turbine 20.

In greater detail, the body 42 is carried at the end of a rod 74 which is fixedly joined to the casing of the turbine 20 and the tube 40 is arranged around the body 42 and connected by radial arms 76 to a sleeve 78 which is mounted so as to slide on the rod 74.

In order to ensure the sealing between the tube 40 and the casing of the turbine 20, the tube 40 is provided, for example, with a sealing segment 80 which slides in a cylindrical hole 82 of the casing of the turbine 20.

In the retracted position of the tube 40, the internal surface of the end 72 is in sealing contact with the body 42 in order to close the channel 39.

The tube 40 can be displaced into a plurality of intermediate positions between its retracted position and its advanced position in order to adjust the openings of the channels 39 and 49.

The displacement of the tube 40 is controlled, for example, by means of a linear actuator (not illustrated) acting on the sleeve 78.

The pipe 36 of the turbine 14 comprises an adjustable closure device 84 which is constituted by a simple valve 86. By way of a variant, the pipe 36 is closed by an adjustable nozzle 38 as described above.

In FIG. 3, one half (to the left in FIG. 3) of the valve 86 is illustrated in a closure position and the other half (to the right in FIG. 3) is illustrated in an open position.

During operation, at a low engine speed, the tube 40 is in a retracted position, the channel 49 is open and the channel 39 is closed, all the gases of the pipe 26 are successively depressurised in the turbine 20 and the turbine 14 which operate in series, as illustrated by an arrow C. The pipe 36 is closed.

When the engine speed increases, the tube 40 is progressively advanced in order to produce an increasing flow of derived gases in the channel 39 which accelerate the depressurised gases in the turbine 20 which are discharged into the channel 49. The pipe 36 is kept closed.

Starting from a given position of the tube 40, the valve 86 is progressively opened when the tube 40 carries on its movement for opening the channel 39 and closing the channel 49. A derived flow is thus brought about in the pipe 36.

Starting from a second position of the tube 40, the tube 40 is quickly advanced in order to move its end 72 into sealing contact with the internal wall of the widened portion 46a in order to close the channel 49 and open the channel 39 wide. At the same time, the valve 86 is moved into a fully open state in order to allow the gases depressurised in the turbine 20 to be discharged into the pipe 36 in accordance with the arrow B1. The turbines 14 and 20 then operate in parallel. The turbine 14 is directly charged by the pipe 26 via the channel 39 in accordance with the arrow B2.

In this manner, the device of FIG. 3 allows a change, in a simple and continuous manner, from a pure series configuration to a series configuration with derivation from the high-pressure turbine, then a series configuration with derivation from the high-pressure and low-pressure turbines in order to result in a parallel configuration.

This change in configuration is brought about by means of the single actuator of the movable member (tube 40) of the nozzle 34, which simplifies the control device and reduces production costs.

Furthermore, in a parallel configuration, the use of the channel 39 having the same axis as the portion 46 which charges the turbine 14 allows a limit of the charging losses and consequently increases the overall yield of the device 8.

The device 8 of FIG. 3 is particularly suitable for carrying out a two-step turbocompression method as described in FR 2 853 011, in which the turbines operate in series below a predetermined speed, and in parallel above that predetermined speed. The device according to FIG. 3 allows an improvement in the yield in the configurations in which the turbines are in series and partially bypassed.

In an advanced position of the tube 40, in order to allow convenient discharge of the gases which are depressurised in the turbine 20, in the maximum opening position of the valve 86, the pipe 36 preferably has a cross-section that is substantially equal to the cross-section of the pipe 28.

In accordance with a method for use of the device of FIG. 3, a change is brought about from a configuration of the turbines in series to a configuration of the turbines in parallel (for example, above a predetermined speed), by displacing the tube 40 into a position for closing the channel 49 and displacing the valve 86 at the same time into a maximum opening position.

When the pipe 36 opens in the exhaust pipe 30 of the turbine 14, it is advantageous to replace the valve 86 with a nozzle 38, as in FIGS. 1 and 2.

In a variant which is not illustrated, the body 42 is also movable relative to the turbine 20 in order to be able to modify the openings of the channels 39 and 49 independently.

1. Supercharging device for an internal combustion engine, of the type comprising a high-pressure turbine which is connected to a compressor, a pipe for charging the high-pressure turbine with pressurised gases, an exhaust pipe for the gases which are depressurised in the high-pressure turbine, and bypass means for the high-pressure turbine comprising a bypass pipe which connects the charging pipe to the exhaust pipe, and a low-pressure turbine which is connected to a compressor and which is charged with gases from the exhaust pipe of the high-pressure turbine, wherein the bypass pipe of the high-pressure turbine opens in the exhaust pipe of the high-pressure turbine via a pressure-reduction nozzle which allows the gases derived by the bypass pipe to be discharged in a mixing portion of the exhaust pipe substantially in accordance with the direction and sense of flow in the mixing portion of the gases which are depressurised in the high-pressure turbine, in order to increase the flow rate of the gases which are depressurised in the high-pressure turbine by mixing with the derived gases in accordance with the principle of an aerodynamic ejector, whose propulsion flow is constituted by the gases which are derived by the bypass pipe of the high-pressure turbine, and the conveyed flow is drawn from the gases which are depressurised in the high-pressure turbine.

2. Device according to claim 1, wherein the cross-section of the neck of the nozzle is adjustable.

3. Device according to claim 2, wherein the cross-section of the neck of the nozzle of the bypass means of the high-pressure turbine is adjustable between a minimum value, preferably zero, and a maximum value of between one and two times the critical cross-section of the high-pressure turbine, and the critical cross-section of the low-pressure turbine is between two and three times the critical cross-section of the high-pressure turbine.

4. Device according to claim 1, wherein the nozzle is constituted by a convergent annular channel which is delimited by the internal wall of a convergent tube and the external wall of a central body, whose relative position can be adjusted between a position for closing the nozzle and a maximum opening position of the nozzle.

5. Device according to claim 4, wherein the convergent tube is fixed relative to a casing of the high-pressure turbine and the central body can be moved relative to the casing.

6. Device according to claim 4, wherein the mixing portion is charged with gases which are depressurised in the high-pressure turbine via an annular channel which is delimited between a widened portion which extends the mixing portion in an upstream direction and an external wall of the convergent tube of the nozzle.

7. Device according to claim 6, wherein the convergent tube can be moved relative to a casing of the high-pressure turbine between a position for closing the channel of the nozzle, and a position for closing the annular channel for charging the mixing portion with gases which are depressurised in the high-pressure turbine.

8. Device according to claim 7, wherein the central body of the nozzle can be moved relative to the casing of the high-pressure turbine.

9. Device according to claim 1, wherein the internal wall of the mixing portion is a ruled surface which is supported on a circular intake cross-section of the mixing portion and on the critical cross-section of the volute for charging the low-pressure turbine so as to constitute a tangential extension of that volute.

10. Device according to claim 1, wherein it comprises bypass means of the low-pressure turbine, comprising a second bypass pipe which is charged from the exhaust pipe of the high-pressure turbine upstream of the nozzle.

11. Device according to claim 10, wherein it comprises an adjustable closure device of the second bypass pipe in order to adjust the flow of derived gases in the second bypass pipe.

12. Device according to claim 11, wherein, when the closure device is in a maximum opening position, the second bypass pipe has a cross-section that is substantially equal to the cross-section of the exhaust pipe of the high-pressure turbine.

13. Device according to claim 10, wherein the second bypass pipe opens in a mixing portion of a second exhaust pipe of the gases which are depressurised in the low-pressure turbine via a pressure-reduction nozzle which allows the discharge of the derived gases via the second bypass pipe in the mixing portion of the second exhaust pipe substantially in the direction and sense of flow in the mixing portion of the gases which are depressurised in the low-pressure turbine, in order to increase the flow rate of the gases which are depressurised in the low-pressure turbine by mixing with the derived gases in accordance with the principle of an aerodynamic ejector, whose propulsion flow is constituted by the gases which are derived by the second bypass pipe of the low-pressure turbine, and the conveyed flow is drawn from the gases which are depressurised in the low-pressure turbine.

14. Device according to claim 13, wherein the second mixing portion opens in a divergent diffuser which opens at means for processing the exhaust gases.

15. Device according to claim 1, wherein the low-pressure turbine is a radial turbine which is charged with gases by a volute.
